(19) United States
(12) Patent Application Publication
(10) Pub. No.: US 2006/0005961 A1
(43) Pub. Date: Jan. 12, 2006

(54) Heat exchanger temperature control system

(76) Inventors: Robert Ashe, Shenley (GB); David Morris, Appleton (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/511,259

(22) PCT Filed: Apr. 15, 2003
(86) PCT No.: PCT/EP03/03983

§ 371 Date: Aug. 19, 2005

(30) Foreign Application Priority Data
Apr. 24, 2002 (GB) 0209352.4

(51) Int. Cl. G05D 23/00; F28F 27/00

(52) U.S. Cl. 165/296; 165/96

(57) ABSTRACT

A heat exchanger for use in temperature control comprising two or more heat transfer elements containing flowing heating or cooling fluid and in contact with a medium whose temperature is to be controlled by the number of heat transfer elements in operation and which can be varied to control the heat transfer capacity of the heat exchanger wherein the number of heat transfer elements in operation is controlled by measurement of the temperature of the medium to be controlled and the actuator for controlling the number of heat transfer elements in operation is contained within the body of the heat exchanger.

The present invention relates to an alternative method of temperature control in heat exchangers. The method is well suited for use on plate and solid block heat exchangers although it may be used on other types. The concept is illustrated herein in relation to plate heat exchangers.

Plate heat exchangers are devices for adding or removing heat typically from a fluid or gas. They consist of a series of adjacent plates. The plates are spaced apart and profiled in a manner which enables fluids to pass between them. A plate heat exchanger is made up with a minimum of 3 plates. In the case of a 3 plate system, heat transfer fluid is passed through one plate space and the process fluid whose temperature is to be controlled is passed through a neighbouring plate space. This provides an efficient means of transferring heat between the heat transfer fluid and the process fluid. Most plate heat exchangers are made up of many plates and the process fluid and the heat transfer fluids pass between alternating plate spaces.

Plate heat exchangers are used in a wide variety of industrial applications. In some cases, they are used to modify process temperature in preparation for a physical or chemical process step. Examples of this application include temperature adjustment prior to and during many common physical process operations (heat pasteurization, sterilization, extrusion, mixing, crystallization, filtration heat treatment etc.). In other cases they are used to regulate the temperature of stored liquids. In some applications plate heat exchangers are used to control temperature in exothermic and endothermic processes such as chemical synthesis reactions, neutralisation reactions, condensation reactions and polymerization etc.

Plate heat exchangers with temperature control systems are also used for a variety of non-process applications. This includes such examples as controlling air temperature of buildings, the temperature of swimming pools, ponds, cooling towers, machine cooling systems, etc.

The invention is concerned with an improved method of controlling temperature in plate heat exchangers. Multiple benefits arise from the improved temperature control method.

The new control method of the present invention gives faster temperature control response and a narrower temperature control band. This will give better product quality and yield for temperature sensitive chemical reactions and processes.

The new control method provides stable temperature in the process fluid with a high thermal difference between the heat transfer fluid and the process fluid. This enables smaller plate heat exchangers to be used for a given duty. It also enables more even temperature profiles to be maintained where heat is being liberated by the process.

The new control method also enables accurate measurement of the amount of heat being absorbed or liberated by a process.

The new control method will also offer energy savings in the form of reduced pumping requirements of heat transfer fluid. In the case of heat exchangers used for cooling, higher heat transfer fluid return temperatures will enable users to pre-cool the return fluid with lower grade cooling fluid. This will reduce energy costs.

The amount of heat which a heat exchanger can deliver is based on the standard heat exchanger equation:
Q=U×A×LMTD (kW)
Where Q (kW) is the process heat load. This can be the chemical heat load arising from a reaction between two chemicals or some other type of reaction such as polymerization. Alternatively it could be the heat load associated with a physical change such as crystallisation, evaporation or precipitation. In some cases, the heat load (Q) may be a sensible heat load for heating or cooling process fluids.

U is the overall heat transfer coefficient (kW.m⁻².K⁻¹) and is a measure of how easily heat can be transmitted between the process fluid and the heat transfer fluid. It is dependent upon the physical properties of the heat exchanger and the physical and dynamic properties of the heat transfer fluid and the process fluid. For example a thin heat transfer wall fabricated in a material with high thermal conductivity gives a better overall heat transfer capacity. Heat transfer fluids with high thermal conductivity give a better overall heat transfer coefficient. Reducing the thickness of the fluid boundary layers (heat transfer fluid and process fluid) also gives a better overall heat transfer coefficient. This may be achieved by such methods as increasing the velocity of the fluid within the heat exchanger and using low viscosity fluids.

A is the heat transfer area of the heat exchanger (m²). A larger heat transfer area gives a higher heat transfer capacity. In the case of a plate heat exchanger, the heat transfer area is determined by the surface area of each plate and the number of plates used.

LMTD is the log mean temperature difference and is the difference in temperature between the heat transfer fluid and the process fluid. This is expressed as a mathematical function since the temperatures of the respective fluids (heat transfer fluid and process fluid) are not constant. The LMTD is calculated as follows:
LMTD=(ΔTᵢₙ−ΔTₒᵤₜ)/In(ΔTᵢₙ/ΔTₒᵤₜ)
Where ΔTᵢₙ is the difference in temperature (between the heat transfer fluid and the process fluid) at the inlet of the heat exchanger and ΔTₒᵤₜ is the difference in temperature (between the heat transfer fluid and the process fluid) at the outlet of the heat exchanger.

A heat exchanger is usually sized for the maximum load it can encounter in the course of its operation. In practice however, it will be required to operate over a wide variety of operating heat loads. The load variation arises during start up and shutdown, or during process upsets. Load variation is also encountered when equipment is used at different times. For example a heat exchanger might be used to heat a fluid being pumped out of a storage tank. The storage tank temperature may be different according to the weather and the season. The same environmental effect applies to a heat exchanger being used for air conditioning or room heating. Load variation is also encountered when heat exchangers are used for different purposes. For example, different products and manufacturing recipes require different heat loads during processing.

To explain how conventional heat exchangers regulate temperature, an example will be used of a theoretical heat exchanger with a heat transfer area of 1 m² and an overall heat transfer coefficient of 1 kW.m⁻².°C⁻¹. Imagine that a fluid is fed to the heat exchanger at 30° C. and needs to be heated to 40° C. Assume that the flow rate of the process fluid is 1 kg.s⁻¹ and has a specific heat of 1 kJ.kg⁻¹.°C⁻¹. The heat load (Qₚ₁) required to raise the temperature by 10° C. can therefore be calculated as follows:
Qₚ₁=m×Cp×Δt
Where m is the mass flow of process fluid (kg)
Cp is the specific heat of the process fluid (kJ.kg ⁻¹.°C¹)
Δt is the temperature rise of the process fluid (° C.).

Thus Qₚ₁=1×1×(40−30)=10 kW

The mean temperature difference between the heat transfer fluid and the process fluid can be calculated using the heat exchanger equation:
Q=U×A×LMTD

For the temperature to be controlled, the process load must match the heat exchanger capacity thus:
Q=Qₚ₁

Therefore Qₚ₁=U×A×LMTD

Since the values of Qₚ₁ (1 kW), U (1 kW.m⁻².°C⁻¹) and A (1 m²) are known, the mean thermal difference between the process fluid and the heat transfer fluid (LMTD) is calculated as 10° C.

Imagine that the feed temperature of the process fluid falls to 20° C.

Thus Qₚ₂=1×1×(40−20)=20 kW

Since the values of Qₚ₂ (1 kW), U (1 kW.m⁻².°C⁻¹) and A (1 m²) are known, the new mean thermal difference between the process fluid and the heat transfer fluid (LMTD) can be calculated and is 20° C.

It can be seen from the example above that the LMTD in the heat exchanger conditions have to be modified when the process heat load changes. This can be achieved in one of two ways.
Firstly hotter heat transfer fluid could be fed to the heat exchanger. This would increase the average temperature of the heat transfer fluid within the system.
Alternatively heat transfer fluid could be pumped through the heat exchanger faster. This would also increase the average temperature of the heat transfer fluid within the system.

The illustration above demonstrates how conventional heat exchangers control temperature by modifying the LMTD. A variety of techniques are used for regulating the flow and temperature of the heat transfer fluid. Although good performance can be achieved with this type of control method, there are disadvantages.

Such a process is described in U.S. Pat. No. 3,047,244 which shows a variable area heat exchanger comprising a series of individual pipes each of which is provided with a jacket through which a heat transfer fluid is provided to alter the temperature of a fluid passing through the individual pipes. The system may be used to heat water passing through the pipes by means of steam which passes through the jackets. As the need for hot water increases or decreases, the number of pipe and jacket combinations that are in operation is increased or decreased. The pipe and jacket combinations are brought in or out of operation by linked valve systems that are synchronised for simultaneous opening and closing of the pipe and jacket of each combination. This is not a system in which the ability to heat or cool a process fluid is altered by varying the area of the surface of heat exchanger that is available to the medium whose temperature is to be controlled.

LMTD is not the only means available for regulating process temperature. Variable heat transfer area can also be used. In our co-pending PCT Publications WO02/088191, WO02/087752, WO02/087753 and WO02/088851, we describe and claim reactor systems which provide improved control over physical and/or chemical reactions. In particular these applications describe how the heat transfer area can be varied by means of a series of conduits particularly pipes or coils which can be brought into or out of operation. We have now developed an internal control system which can be used for a variety of existing heat exchangers such as plate or solid block heat exchangers. Our co-pending United Kingdom Patent Application WO02/087753 describes measurement systems which may be used with this invention.

The present invention provides a modification which enables plate heat exchangers (or solid block heat exchangers) to operate as variable area heat exchangers so that the area may be modified when the process heat load changes as opposed to the conventional technique of changing LMTD.

The present invention therefore provides a heat exchanger for use in temperature control comprising two or more heat transfer elements containing flowing heating or cooling fluid and in contact with a medium whose temperature is to be controlled by the number of heat transfer elements in operation and which can be altered to provide means of controlling the heat transfer capacity of the heat exchanger wherein the number of heat transfer elements in operation is controlled by measurement of the temperature of the medium to be controlled and wherein the actuator for controlling the number of heat transfer elements in service is contained within the body of the heat exchanger.

The heat exchangers of the present invention may contain any number of elements typically eight or more, sometimes fifteen or more and in some instances fifty or more.

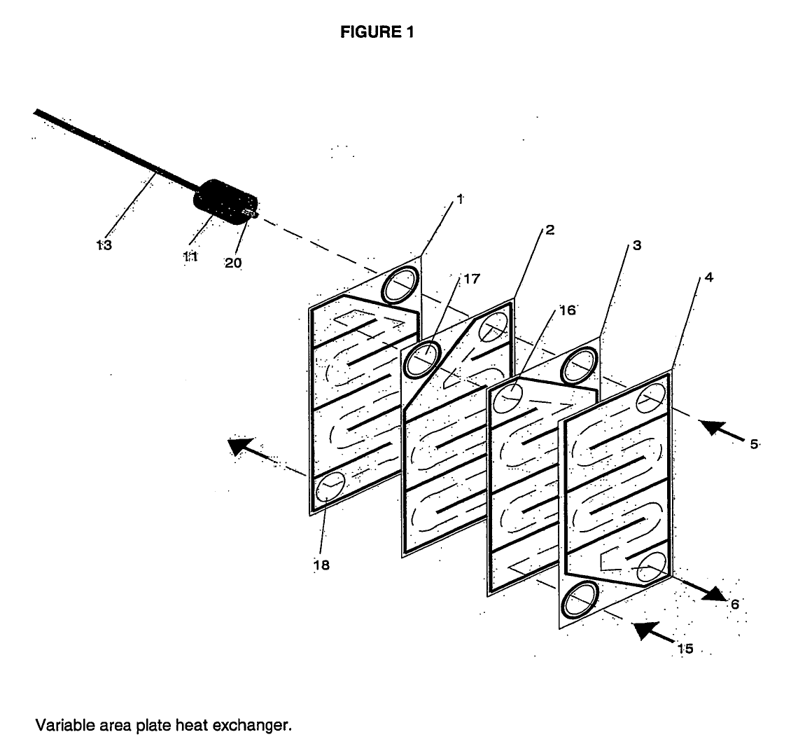

In a preferred embodiment the heat exchanger is a plate heat exchanger consisting of multiple plates. FIG. 1 shows an exploded view of a plate heat exchanger with 4 plates which may be brought in and out of use to vary the area available (items 1 to 4). Heat transfer fluid enters and leaves via common manifold pipes (items 5 and 6). The heat transfer fluid passes through alternate plate cavities fed by a common manifold.

The process fluid takes a different flow path (items 15 to 18) and flows across alternate plates. The key difference between this design and conventional plate heat exchangers is that the number of plates in service can be varied by using a piston (item 11) which acts an actuator and passes through one of the fluid (inlet or outlet) manifolds. The piston (11) is driven by a shaft (item 13). FIG. 1 also shows a temperature measuring element on the shaft (item 20). The purpose of this is described later.

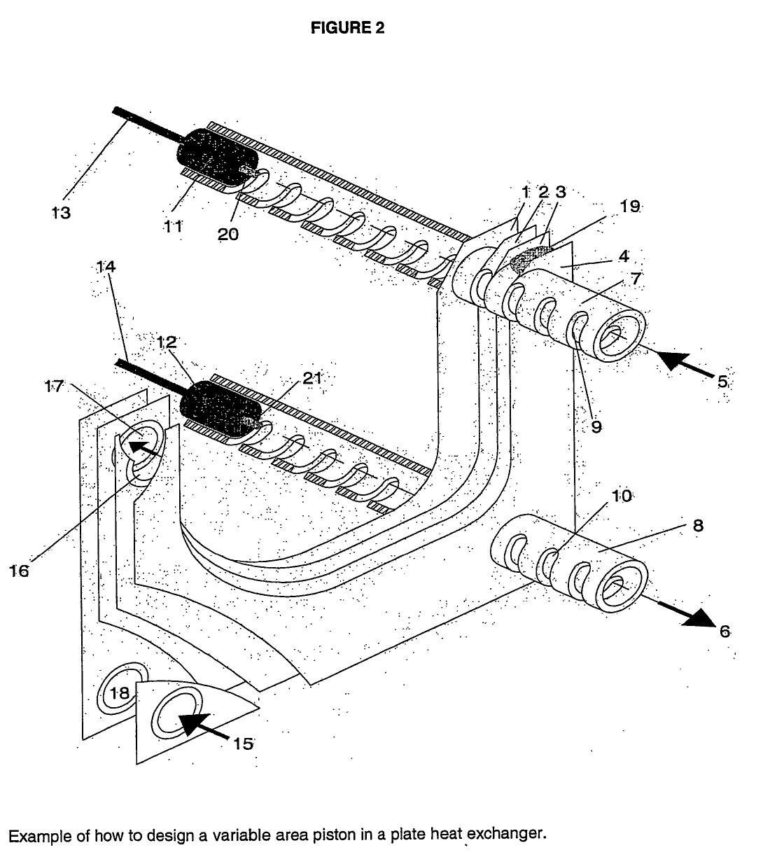

The embodiment illustrated in FIG. 1 enables the number of plates in service at any time to be varied by changing the position of the piston. This effectively controls the number of plates in service and hence the total area that is available for heat transfer. Different mechanical design solutions could be employed to ensure that the piston can travel through the heat exchanger with ease. FIG. 2 gives an example of one method which consists of providing a piston actuator in a variable area plate heat exchanger. In FIG. 2, items 1 to 4 are the plates. Items 5 and 6 in FIG. 2 show heat transfer fluid entering and leaving the manifold. Items 7 and 8 are the flow and return pipes. Each pipe has apertures (items 9 and 10) spaced along the length. These enable fluid to enter and leave the plate. It must be recognized that FIG. 2 is a cut away view and that not all the plates are shown. In the embodiment illustrated in FIG. 2, pistons are shown on both the flow and return pipes (items 11 and 12). These pistons have shafts (items 13 and 14) and temperature sensing devices (items 20 and 21). The process flow path is shown by items 15 to 18. FIG. 2 shows a sealing gasket (item 19) between the plates, but a fully welded design could equally well be used.

In FIGS. 1 and 2, the control piston (or pistons) has been used on the heat transfer fluid side of the heat exchanger. This has the advantage of keeping moving parts away from the process fluid. In some instances however it might be preferable to mount the control piston (or pistons) in the process fluid.

The plate heat exchanger of the present invention can be used with a single piston or a piston on both the flow and return pipes. The use of two pistons can be of benefit where heat is being measured.

The actuator which controls the number of plates in service could be operated by a number of methods other than a piston moving through the plates. For example, a hollow piston with holes or slots formed in a spiral manner down the length could be used to progressively open up plates as the shaft is rotated. The number of plates in service could also be varied by means of an inflatable inner tube contained within a solid tube. In this case, the heat transfer fluid (or alternatively the process fluid) passes between the soft inner tube and the hard tube. Flow to the plates is via apertures in the hard pipe. Flow of heat transfer fluid in this example is stopped when the soft inner tube is expanded onto the wall of the hard tube. The soft inner tube may be expanded onto the hard pipe by a variety of methods including a piston or fluid/gas under pressure. Multiple on off valves contained within the pipe could also be used. In the case of a solid block heat exchanger, the piston or actuator could be fitted within the body of the block without the need for a containment pipe.

Temperature measuring devices can be fitted to the pistons (item 20 in FIG. 1 and items 20 and 21 in FIG. 2). This will give faster temperature measuring response which would be useful for some applications.

Where the actuator is a piston which passes through the plates it needs to travel freely in either direction. The piston can be driven by a variety of methods, for example it may be a hydraulic piston with spring return, a double acting hydraulic piston, an electrical motor with gears, compressed air or a linear motor. Other types of motive force could also be used.

By varying the number of plates in service, the user is able to vary and control the heat transfer area. In this way the temperature of the medium whose temperature is to be controlled may be controlled using a constant heat flux from the controlling fluid to the medium or vice versa. If the heat exchanger has 3 plates, temperature regulation is reduced to simple on/off control. Such a design would neither need nor benefit from an internal control piston. A heat exchanger has to have more than one complete flow passage for the given fluid to create a variable area heat transfer surface. In this context, one flow passage refers to the volume between two plates. An ideal system has a large number of plates such as more than 15, perhaps more than 50 plates. With a large number of plates, small incremental changes in the heat transfer capacity is observed when the actuator opens up or closes each new plate. If the heat transfer area can be changed in small increments, the temperature control system will operate more smoothly.

There are however limits to the number of plates that can be used. Quite apart from practical limitations of using large numbers of plates, there will be occasions when only a small proportion of the plates are in service. Since the heat load will rarely coincide with an exact number of plates a means of controlling intermediate heat loads (between the incremental steps) is preferably provided. This can be achieved by permitting the actuator to rapidly open and close one plate. The fluctuating flow will have the effect of giving reduced cooling capacity. Another method is to give the actuator very fine position control. By partially opening flow to the leading plate, a reduced flow of fluid is delivered to this one element. The lower flow through this plate will give a reduced temperature difference (LMTD) within this plate. Therefore, on this one leading plate, the heating or cooling capacity will be smaller than the other plates (which are fully open).

Where the actuator is a piston, the direction, distance of travel and speed of travel of the piston can be regulated by a controller using a temperature signal from the process. For this, conventional or purpose made controllers can be used. Alternatively the actuator can be controlled by some other factor such as a pre-programmed recipe. In some cases it may be preferable to use a combination of a pre-programmed recipe and some other process signal. An example of another signal referred to here could be a flow device or computer signal which occurs when a particular process stream is switched on.

The method described above provides control of heat transfer by varying the area of the heat transfer surface and maintaining substantially constant heat flux between the heating or cooling fluid and the medium whose temperature is to be controlled. It is preferred that the temperature difference between the heat transfer fluid and the material whose temperature is to be controlled is at least 5° C. and preferably from 5° C. to 100° C. This enables faster temperature control response and more stable temperature control. In addition it will allow the use of smaller heat exchangers for a given duty without sacrificing temperature control stability. Although some small temperature changes are observed when plates are opened or closed (and some flow control may be imposed on the leading plate as described earlier), the underlying means of control is by varying the heat transfer area. Some of the advantages of this method are described below. For the purposes of this example it is assumed that the actuator is a control piston located in the heat transfer fluid rather than the process fluid.

Some advantages of the heat exchanger of the present invention are:
I. Very large temperature differences (between the heat transfer fluid and the process fluid) such as from 5° C. up to 100° C. or even higher can be used to control the process temperature without suffering control instability. The high temperature difference delivers heat to the heat transfer surface more quickly. This gives a faster temperature control response. This provides a benefit when compared with the majority of heat transfer elements which operate fully open and are therefore at constant flow and temperature. This reduces control instability.
II. The user can modify the feed temperature of the heat transfer fluid to ensure that a useful number of plates are ulitised for control purposes. This ensures smooth control over a wide range of heat loads. It should be recognized that a reduced temperature difference (between the heat transfer fluid and the process fluid) gives a slower temperature control response. In a further embodiment both the heat transfer area and the feed temperature of the heat transfer fluid can be controlled; This would enable systems to automatically optimize the operating conditions.
III. The user can modify the feed pressure of the heat transfer fluid to vary flow through the plates. Reduced flow of heat transfer fluid would be useful where the system was being used to measure enthalpy gain or release by a process.
IV. Variable area control delivers heat transfer fluid at constant temperature and pressure to all but one of the plates. This is in direct contrast to conventional heat exchanger control systems where temperature or flow within a group of plates is varied to control process temperature. The benefit of maintaining a substantially constant temperature and flow through most of the plates is that enthalpy (entering or leaving the process) can be measured with much greater accuracy and without compromising temperature control performance. Thus, by measuring the flow and temperature change of the heat transfer fluid, accurate calorimetric data can be collected.
V. Variable area temperature control is ideal for very small or micro heat exchangers where a small piston controller is easier to build and control than a conventional temperature control valve.
VI. A feature of variable area control is that the heat transfer fluid remains at a substantially constant temperature. This means that products sensitive to extremes of hot and cold can be protected from temperature damage when large heat load changes arise.

The present invention therefore delivers performance improvements for any plate or block heat exchanger that relies on temperature control. The ability to select heat flux and to keep the heat flux constant allows smaller heat exchangers to be employed without sacrificing temperature control. Apart from the cost benefits of smaller heat exchangers, this is a valuable characteristic for heat exchangers used in places where space and weight is at a premium such as oilrigs, road vehicles, aircraft and ships. The high flux capability with stable temperature control enables users to employ smaller volumes of heat transfer fluid. This reduces pumping capacity (for the heat transfer fluid) and delivers a higher (or lower in the case of heat duties) return temperature. This offers the prospect of using more lower grade heat. The improved temperature control characteristics provided by the present invention will give better product quality and yield when handling heat sensitive materials particularly in chemical and physical reactions. The improved control will also reduce the likelihood of product damage due to transient temperature deviations. The present invention also provides the ability to measure heat released or absorbed by the process with much greater accuracy which is a very valuable process control tool.

Whilst there are different design considerations in using variable area control to its best advantage, this technology can be applied to any plate heat exchanger providing there is more than one flow passage to be controlled. It can be fitted to new heat exchangers or retro fitted to old ones. It can be used with liquids or gases and can be employed on the heat transfer fluid side or the process fluid side.

The improved heat exchangers of the present invention may be used to control the temperature of water, air, food products during processing, organic synthesis reactions, polymerisation reaction, batch reactions and continuous reactions. They may also be used for temperature control applications in aircraft, ships, railroad and road vehicles. They may also be used for temperature control on oilrigs or drilling platforms.

What is claimed is:

1. A heat exchanger for use in temperature control comprising two or more heat transfer elements containing flowing heating or cooling fluid and in contact with a medium whose temperature is to be controlled by the number of heat transfer elements in operation and which can be varied to control the heat transfer capacity of the heat exchanger wherein the number of heat transfer elements in operation is controlled by measurement of the temperature of the medium to be controlled and the actuator for controlling the number of heat transfer elements in operation is contained within the body of the heat exchanger.

2. A heat exchanger according to claim 1, in which the heat transfer fluid is delivered to each flowing heat transfer element at substantially constant flow and temperature.

3. A heat exchanger according to claim 1, wherein the heat transfer area is the only variable controlled by measurement of the temperature of the medium whose temperature is to be controlled.

4. A heat exchanger according to claim 1, in which the heating or cooling fluid is a non isothermal heating or cooling medium.

5. A heat exchanger according to claim 1, in which the material whose temperature is to be controlled is contained within a single conduit and the variable area heat transfer surface is achieved by segregating the heat transfer fluid into multiple separate conduits which can be opened or closed in a cascade fashion according to the quantity of heating or cooling required.

6. A heat exchanger according to claim 1, in which the heat transfer fluid is contained within a single conduit and the variable area heat transfer surface is achieved by segregating the material whose temperature is to be controlled into multiple separate conduits which can be opened or closed in a cascade fashion according to the quantity of heat or cooling required.

7. A heat exchanger according to claim 1, which maintains a temperature difference of at least 5° C. between the heat transfer fluid and the material whose temperature is to be controlled.

8. A heat exchanger according to claim 1 which maintains a temperature difference of from 5° C. to 100° C. between the heat transfer fluid and the fluid whose temperature is to be controlled.

9. A heat exchanger according to claim 1, which maintains a substantially constant temperature difference between the heat transfer fluid and the material whose temperature is to be controlled.

10. A heat exchanger according to claim 1 in which the heat transfer surface is segregated into 5 or more separate elements.

11. A heat exchanger according to claim 1, which is a plate heat exchanger.

12. A heat exchanger according to claim 1, which is a solid block heat exchanger formed of a solid drilled block or a sandwich of sections with machined slots.

13. A heat exchanger according to claim 1, in which the actuator for varying the heat transfer area is a piston which can be moved through the plates or heat transfer elements so as to open or close the heat transfer elements to flow.

14. A heat exchanger according to claim 1 in which the actuator is a piston with holes which may be rotated so as to open or close the plates or heat transfer elements to flow.

15. A heat exchanger according to claim 1 in which the actuator used for varying the heat transfer area comprises of a soft inner pipe being compressed against a hard outer pipe so as to open up the heat transfer surface in incremental steps.

16. A heat exchanger according to claim 1 in which the individual conduits are controlled by multiple separate valves.

17. A heat exchanger according to claim 1 in which the valve or valves for variable area control such that the flow through the leading element can be varied for fine control purposes.

18. A heat exchanger according to claim 1 provided with a control system in which the heat transfer area is varied in order to modify or control the temperature of the fluid whose temperature is to be controlled.

19. A heat exchanger according to claim 1, wherein the heat transfer area is controlled by a signal from the material whose temperature is to be controlled.

20. A method for controlling temperature, said method comprising:
passing a gas, liquid and/or solid material through a heat exchanger comprising two or more heat transfer elements containing flowing heating or cooling fluid and in contact with a medium whose temperature is to be controlled by the number of heat transfer elements in operation and which can be varied to control the heat transfer capacity of the heat exchanger wherein the number of heat transfer elements in operation is controlled by measurement of the temperature of the medium to be controlled and the actuator for controlling the number of heat transfer elements in operation is contained within the body of the heat exchanger.

21. The method according to claim 20, wherein said method controls the temperature of water.

22. The method according to claim 20, wherein said method controls the temperature of food products during processing.

23. The method according to claim 20, wherein said method controls the temperature of organic synthesis reactions.

24. The method according to claim 20, wherein said method controls the temperature of polymerisation reactions.

25. The method according to claim 20, wherein said method controls the temperature of temperature sensitive materials.

26. The method according to claim 20, wherein said method controls the temperature of continuous reactions.

27. The method according to claim 20, wherein said method controls the temperature of heat exchangers used in road vehicles.

28. The method according to claim 20, wherein said method controls the temperature of heat exchangers used in applications at sea such as ships or drilling platforms.

29. The method according to claim 20, wherein said method controls the temperature of heat exchangers used in aircraft.

30. The method according to claim 20, wherein said method controls the temperature or measuring heat on very small or micro scale heat exchangers.
